(19) United States
(12) Patent Application Publication
(10) Pub. No.: US 2026/0084100 A1
(43) Pub. Date: Mar. 26, 2026

(54) Separation Device And Method For Designing Separation Device

(71) Applicant: SEIKO EPSON CORPORATION, Tokyo (JP)

(72) Inventors: Satoru FUKUI, Chino (JP); Kei TADACHI, Matsumoto (JP)

(21) Appl. No.: 19/339,762

(22) Filed: Sep. 25, 2025

(30) Foreign Application Priority Data
Sep. 26, 2024 (JP) 2024-167114

(51) Int. Cl. B01D 53/22; B01D 69/10; B01D 71/70

(52) U.S. Cl. CPC B01D 53/228; B01D 53/227; B01D 69/10; B01D 71/70; B01D 2256/10; B01D 2257/504; B01D 2258/06

(57) ABSTRACT

To provide a separation device for selectively separating a carbon dioxide gas from a supply gas, and the separation device includes: a separation membrane configured to selectively allow the carbon dioxide gas contained in the supply gas to permeate; an accommodation portion formed with an accommodation space for accommodating a permeation gas that permeates the separation membrane; a pipe coupled to the accommodation portion; and a pump configured to reduce a pressure in the accommodation space via the pipe and draw in the permeation gas, in which (P1/P2)/(A/B)≥1, in which A is carbon dioxide gas permeability of the separation membrane, B is nitrogen gas permeability of the separation membrane, P1 is a total pressure of the supply gas, and P2 is a total pressure of the permeation gas in the accommodation space, and 1>(B+C)/(A+C)≥0.8, in which C is gas permeability of a flow path of the permeation gas between the separation membrane and the pump.

The present application is based on, and claims priority from JP Application Serial Number 2024-167114, filed Sep. 26, 2024, the disclosure of which is hereby incorporated by reference herein in its entirety.

### BACKGROUND

### 1. Technical Field

The present disclosure relates to a separation device and a method for designing a separation device.

### 2. Related Art

In order to implement carbon neutrality, a technique is considered to capture and collect a carbon dioxide gas from atmosphere. As one such technique, a membrane separation method is known, in which a separation membrane is used to separate target gases such as the carbon dioxide gas from mixed gases like the atmosphere.

For example, JP-A-60-75320 discloses a separation membrane including a porous support, a thin film of a siloxane compound disposed on the porous support and having a surface layer plasma-treated with a non-polymerizable gas, and a plasma polymerized film disposed on the thin film. The porous support supports the thin film and the polymerized film. A mixed gas is supplied to the thin film and the polymerized film. In the thin film and the polymerized film, permeability of a target gas in the mixed gas is higher than permeability of a non-target gas in the mixed gas. Therefore, the separation membrane can selectively separate the target gas from the mixed gas.

JP-A-60-75320 is an example of the related art.

The separation membrane is used, for example, by being incorporated in a separation device. The separation device includes, for example, an accommodation portion that accommodates a gas that permeates the separation membrane, and a pump that reduces a pressure in the accommodation portion and draws in the gas that permeates the separation membrane. A ratio of the permeability of the target gas to the permeability of the non-target gas of the separation membrane is referred to as “selectivity”. Even when a separation membrane having good selectivity is incorporated in the separation device, selectivity of the separation device may be significantly lower than the selectivity of the separation membrane depending on a configuration of a portion other than the separation membrane in the separation device.

### SUMMARY

A separation device according to an application example of the present disclosure is a separation device for selectively separating a carbon dioxide gas from a supply gas containing the carbon dioxide gas and a nitrogen gas, and the separation device includes: a separation membrane including a porous body and a resin layer disposed on the porous body and configured to selectively allow the carbon dioxide gas contained in the supply gas to permeate toward the porous body; an accommodation portion holding the separation membrane and formed with an accommodation space for accommodating a permeation gas that permeates the separation membrane; a pipe coupled to the accommodation portion; and a pump configured to reduce a pressure in the accommodation space via the pipe and draw in the permeation gas, in which 500,000 GPU≥A≥1,000 GPU, in which A is carbon dioxide gas permeability of the separation membrane, (P1/P2)/(A/B)≥1, in which B is nitrogen gas permeability of the separation membrane, P1 is a total pressure of the supply gas, and P2 is a total pressure of the permeation gas in the accommodation space, and 1>(B+C)/(A+C)≥0.8, in which a flow path of the permeation gas between the separation membrane and the pump includes the accommodation space and an internal space of the pipe, and C is gas permeability of the flow path.

A method for designing a separation device according to an application example of the present disclosure is a method for designing a separation device that selectively separates a carbon dioxide gas from a supply gas containing the carbon dioxide gas and a nitrogen gas, and the method for designing a separation device includes: selecting a separation membrane including a porous body and a resin layer disposed on the porous body and configured to allow the carbon dioxide gas contained in the supply gas to permeate toward the porous body; and designing an accommodation portion holding the separation membrane and formed with an accommodation space for accommodating a permeation gas that permeates the separation membrane, a pipe coupled to the accommodation portion, and a pump configured to reduce a pressure in the accommodation space via the pipe and draw in the permeation gas, in which a flow path of the permeation gas between the separation membrane and the pump includes the accommodation space and an internal space of the pipe, in the selecting, the separation membrane satisfying 500,000 GPU≥A≥1,000 GPU is selected, in which A is carbon dioxide gas permeability of the separation membrane, and in the designing, the pump configured to reduce the pressure in the accommodation space is selected such that (P1/P2)/(A/B)≥1, in which B is nitrogen gas permeability of the separation membrane, P1 is a total pressure of the supply gas, and P2 is a total pressure of the permeation gas in the accommodation space, and the flow path is designed such that 1>(B+C)/(A+C)≥0.8, in which C is gas permeability of the flow path.

### BRIEF DESCRIPTION OF THE DRAWINGS

FIG. 1 is a perspective view illustrating a separation device according to a first embodiment.

FIG. 2 is a cross-sectional view illustrating the separation device according to the first embodiment.

FIG. 3 is an enlarged cross-sectional view of a portion in FIG. 2.

FIG. 4 is a schematic diagram illustrating a method for measuring gas permeability of a flow path in the first embodiment.

FIG. 5 is a flowchart illustrating a method for designing the separation device according to the first embodiment.

FIG. 6 is a cross-sectional view illustrating a separation device according to a second embodiment.

FIG. 7 is a schematic diagram illustrating a method for measuring gas permeability of a flow path in the second embodiment.

FIG. 8 is a cross-sectional view illustrating a separation membrane according to Modification Example 1.

FIG. 9 is a cross-sectional view illustrating a separation membrane according to Modification Example 2.

FIG. 10 is a cross-sectional view illustrating a separation membrane according to Modification Example 3.

FIG. 11 is a cross-sectional view illustrating a separation device according to Comparative Example 1.

FIG. 12 is Table 1 illustrating configurations and evaluation results of separation devices in Examples 1 to 3 and separation devices in Comparative Examples 1 to 3.

### DESCRIPTION OF EMBODIMENTS

Hereinafter, a plurality of embodiments and a plurality of modification examples of the present disclosure will be described with reference to the drawings. The following description is not intended to limit the technical scope or the meaning of terms described in the claims. Dimensional ratios in the drawings are exaggerated for convenience of description, and may be different from actual ratios.

### First Embodiment

First, a separation device 100 according to the first embodiment will be described.

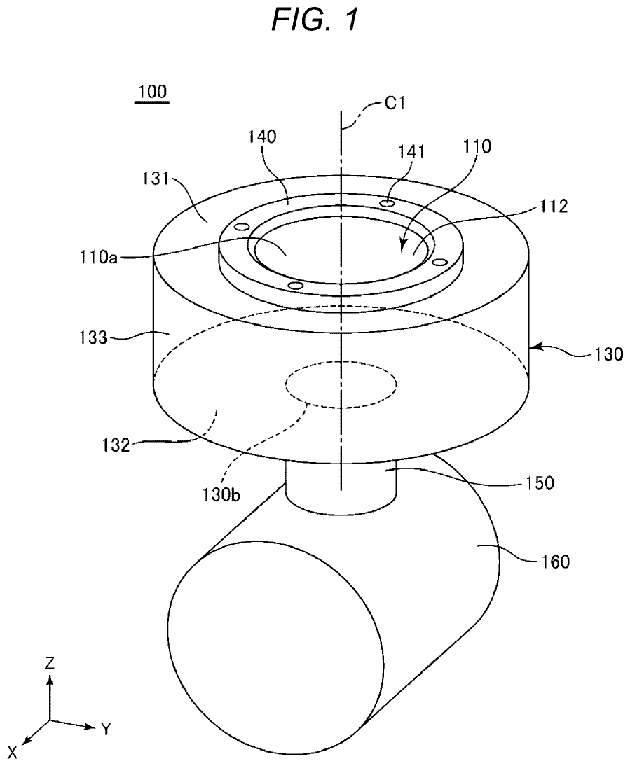

FIG. 1 is a perspective view illustrating the separation device 100 according to the embodiment.

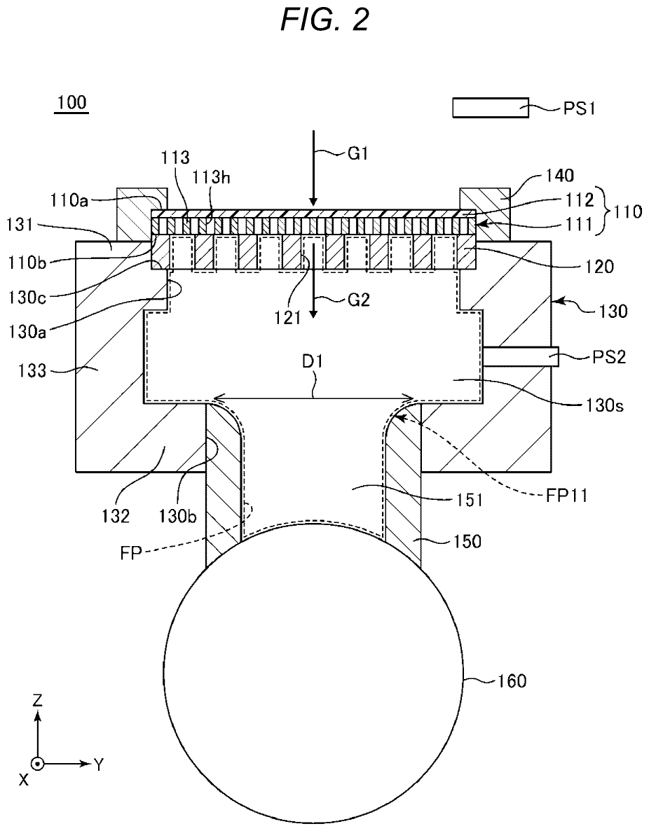

FIG. 2 is a cross-sectional view illustrating the separation device 100 according to the embodiment.

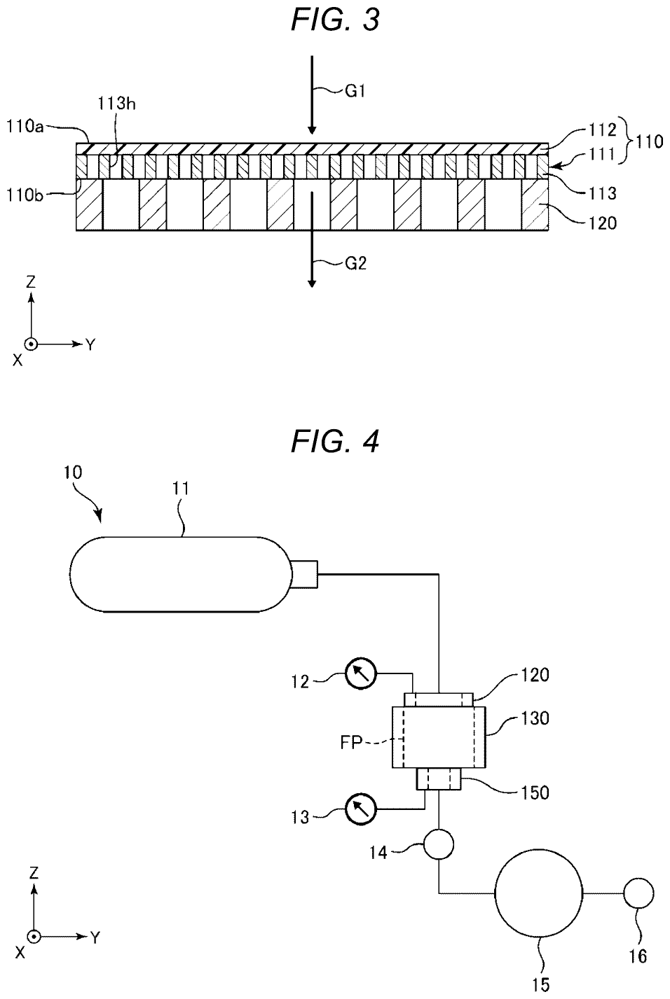

FIG. 3 is an enlarged cross-sectional view of a portion in FIG. 2.

In FIG. 1, a pump 160 to be described later is simply illustrated in a cylindrical shape. Similarly, in FIG. 2, the pump 160 is simply illustrated in a circular shape. In FIG. 2, an accommodation portion 130 and a pipe 150, which will be described later, are illustrated not in a cross section but in an end surface.

In the drawings of the embodiment, an X axis, a Y axis, and a Z axis are set as three axes orthogonal to each other. Each axis is indicated by an arrow, and a tip side of the arrow is defined as “positive”, and a base end side of the arrow is defined as “negative”. In the following description, for example, an “X-axis direction” includes both a positive direction and a negative direction of the X axis. The same applies to a Y-axis direction and a Z-axis direction. In the following description, in particular, a positive side of the Z axis is defined as “upper”, and a negative side of the Z axis is defined as “lower”. The Z axis is not required to be parallel to a vertical axis, and may cross the vertical axis. Hereinafter, an uppermost end of a member is referred to as an “upper end”, and a certain range of the member from the upper end downward is referred to as an “upper end portion”. Similarly, a lowermost end of the member is referred to as a “lower end”, and a certain range of the member from the lower end upward is referred to as a “lower end portion”.

The separation device 100, generally described with reference to FIGS. 1 and 2, includes a separation membrane 110, the accommodation portion 130, the pipe 150, and the pump 160.

A surface of the separation membrane 110 includes a first surface 110a and a second surface 110b forming front and back surfaces. A mixed gas is supplied to the first surface 110a of the separation membrane 110. Hereinafter, the mixed gas supplied to the separation membrane 110 is also referred to as a “supply gas G1”. The supply gas G1 includes a carbon dioxide gas and a nitrogen gas. The supply gas G1 is not particularly limited, and is, for example, atmosphere. In the separation membrane 110, carbon dioxide gas permeability is higher than nitrogen gas permeability. Therefore, the separation membrane 110 can selectively allow the carbon dioxide gas contained in the supply gas G1 to permeate. Accordingly, the separation membrane 110 can selectively separate the carbon dioxide gas from the supply gas G1. Herein, “selectively allowing carbon dioxide gas to permeate or separating carbon dioxide gas” does not mean that only the carbon dioxide gas permeates or is separated, and that the nitrogen gas does not permeate or is not separated at all. “Selectively allowing carbon dioxide gas to permeate or separating carbon dioxide gas” means that the carbon dioxide gas permeates or is separated at higher permeability than the nitrogen gas, that is, the carbon dioxide gas preferentially permeates or is preferentially separated over the nitrogen gas.

The accommodation portion 130 holds the separation membrane 110. The accommodation portion 130 has an accommodation space 130s for accommodating a gas that permeates the separation membrane 110. The second surface 110b of the separation membrane 110 faces the accommodation space 130s. Hereinafter, the gas that permeates the separation membrane 110 is also referred to as a “permeation gas G2”. The separation membrane 110 preferentially allows permeation of the carbon dioxide gas, while also allowing permeation of nitrogen gas. Therefore, the permeation gas G2 includes the carbon dioxide gas and the nitrogen gas.

The pipe 150 is coupled to the accommodation portion 130. The pump 160 reduces a pressure in the accommodation space 130s via the pipe 150. Accordingly, a pressure applied to the first surface 110a of the separation membrane 110 becomes higher than a pressure applied to the second surface 110b. As a result, the permeation of the carbon dioxide gas is promoted in the separation membrane 110. The permeation gas G2 in the accommodation space 130s is drawn and collected by the pump 160.

In the embodiment, the separation device 100 further includes a porous plate 120 supporting the separation membrane 110, and a fixing member 140 for fixing the separation membrane 110 and the porous plate 120 to the accommodation portion 130. Hereinafter, portions of the separation device 100 will be described in detail.

First, the separation membrane 110 will be described.

As illustrated in FIG. 3, the separation membrane 110 includes a porous body 111 and a resin layer 112 disposed on the porous body 111.

In the embodiment, the porous body 111 is implemented with a porous layer 113 in which a plurality of pores 113h are formed. The porous layer 113 extends in the X-axis direction and the Y-axis direction. A shape of the porous layer 113 when viewed from a top is circular in the embodiment. The shape of the porous layer when viewed from the top is not limited to the above, and may be, for example, a polygon such as a rectangle. A lower surface of the porous layer 113 corresponds to the second surface 110b of the separation membrane 110.

The pores 113h penetrate the porous layer 113 in a thickness direction. The thickness direction of the porous layer 113 coincides with the Z-axis direction in the embodiment. The plurality of pores 113h are dispersed on an X-Y plane. Herein, a diameter of an inscribed circle of the pore 113h is defined as a “diameter” of the pore 113h. In the embodiment, the diameter of the pore 113h is constant without substantially changing in the thickness direction.

An average value of diameters of upper ends of the plurality of pores 113h is defined as an “average diameter” of the pores 113h. An average diameter of the pores 113h is preferably 0.01 μm or more and 1000 μm or less, more preferably 0.1 μm or more and 500 μm or less, and still more preferably 0.5 μm or more and 300 μm or less. The average diameter of the pores 113h can be measured by a through-pore diameter evaluation device after removing the resin layer 112 from the separation membrane 110 and taking out the porous layer 113 alone. Examples of the through-pore diameter evaluation device include a perm porometer manufactured by PMI. By setting the average diameter of the pores 113h to be equal to or greater than the above-described lower limit value, the carbon dioxide gas permeability of the porous layer 113 can be improved. By setting the average diameter of the pores 113h to be equal to or less than the above-described upper limit value, mechanical strength of the separation membrane 110 can be improved.

An average value of thicknesses of the porous layer 113 at a plurality of positions on the X-Y plane is defined as an “average thickness” of the porous layer 113. The average thickness of the porous layer 113 is not particularly limited, and is preferably 1 μm or more and 3000 μm or less, more preferably 5 μm or more and 500 μm or less, and still more preferably 10 μm or more and 150 μm or less. The average thickness of the porous layer 113 can be measured by, for example, a scanning electron microscope (SEM). When the average thickness of the porous layer 113 is equal to or greater than the above-described lower limit value, mechanical strength of the separation membrane 110 can be improved. By setting an average thickness of the porous body 111 to be equal to or less than the above-described upper limit value, the carbon dioxide gas permeability of the separation membrane 110 can be improved.

A material for the porous body 111 is, for example, a polymer material, a ceramic material, or a metal material. Examples of the polymer material include polyolefin resins such as polyethylene and polypropylene, fluorine-containing resins such as polytetrafluoroethylene, polyvinyl fluoride, and polyvinylidene fluoride, polystyrene, cellulose, cellulose acetate, polyurethane, polyacrylonitrile, polyphenylene oxide, polysulfone, polyethersulfone, polyimide, polyaramid, and nylon. Examples of the ceramic material include alumina, cordierite, mullite, silicon carbide, and zirconia. Examples of the metal material include stainless steel.

A configuration of the porous body is not limited to the above. For example, as described later, the diameter of the pores formed in the porous body may vary in the thickness direction. The porous body may be formed by a plurality of stacked porous layers.

The resin layer 112 is substantially a dense membrane and has a good affinity for carbon dioxide molecules. Therefore, in the resin layer 112, the carbon dioxide gas permeability is higher than the nitrogen gas permeability. Accordingly, the resin layer 112 selectively allows the carbon dioxide gas in the supply gas G1 to permeate. In the embodiment, the resin layer 112 covers substantially an entire upper surface of the porous body 111. Therefore, in the embodiment, a shape of the resin layer 112 when viewed from the top is circular, similarly to the porous body 111. The shape of the resin layer when viewed from the top is not limited to the above, and may be, for example, a polygon such as a rectangle. An upper surface of the resin layer 112 corresponds to the first surface 110a of the separation membrane 110.

An average value of thicknesses of the resin layer 112 at a plurality of positions on the X-Y plane is defined as an “average thickness” of the resin layer 112. In the embodiment, the average thickness of the resin layer 112 is smaller than the average thickness of the porous body 111. The average thickness of the resin layer 112 is not particularly limited, and is preferably 10 nm or more and 1000 nm or less, more preferably 10 nm or more and 800 nm or less, and still more preferably 30 nm or more and 500 nm or less. The average thickness of the resin layer 112 can also be measured by, for example, SEM. By setting the average thickness of the resin layer 112 to be equal to or greater than the above-described lower limit value, it is possible to reduce occurrence of defects or breakage in the resin layer 112. By setting the average thickness of the resin layer 112 to be equal to or less than the above-described upper limit value, the carbon dioxide gas permeability of the separation membrane 110 can be improved.

A material for the resin layer 112 is a polymer material. Examples of the polymer material include polyolefin resins such as polyethylene and polypropylene, fluorine-containing resins such as polytetrafluoroethylene, polyvinyl fluoride, and polyvinylidene fluoride, polystyrene, cellulose, cellulose acetate, polyurethane, polyacrylonitrile, polyphenylene oxide, polysulfone, polyethersulfone, polyimide, polyaramid, organopolysiloxane, polyethylene terephthalate (PET), polyacetal (POM), and polylactic acid (PLA). The constituent material for the resin layer 112 may be one of the polymer materials or a composite material of two or more of the polymer materials. The polymer material may be a thermoplastic resin, a thermosetting resin, or a photocurable resin.

Among these, organopolysiloxane is preferably used as the constituent material for the resin layer 112. The organopolysiloxane has a good affinity for carbon dioxide molecules.

Next, the porous plate 120 will be described.

In the embodiment, the porous plate 120 has a flat plate shape substantially parallel to the X-Y plane. The porous plate 120 has, for example, a circular shape when viewed from the top. The separation membrane 110 is disposed on the porous plate 120. A plurality of through holes 121 are formed in the porous plate 120. Each of the through holes 121 penetrates the porous plate 120 in the thickness direction. The thickness direction of the porous plate 120 coincides with the Z-axis direction in the embodiment. The plurality of through holes 121 are dispersed on the X-Y plane.

Rigidity of the porous plate 120 is higher than rigidity of the separation membrane 110. Therefore, the porous plate 120 can favorably support the separation membrane 110. As a result, when there is a difference between a pressure applied to the first surface 110a of the separation membrane 110 and a pressure applied to the second surface 110b, deformation and breakage of the separation membrane 110 can be reduced.

A shape of the through hole 121 when viewed from the top is, for example, a circle or a polygon such as a hexagon. A diameter of an inscribed circle of the through hole 121 is defined as a “diameter” of the through hole 121. The diameter of the through hole 121 is substantially constant without changing in the thickness direction of the porous plate 120. An average value of diameters of the plurality of through holes 121 is defined as an “average diameter” of the through holes 121. In the embodiment, the average diameter of the through holes 121 of the porous plate 120 is larger than the average diameter of the pores 113h of the porous body 111. Accordingly, gas permeability of the porous plate 120 can be improved.

The average diameter of the through holes 121 is not particularly limited, and is preferably 0.1 mm or more and 10 mm or less, more preferably 0.5 mm or more and 5 mm or less, and still more preferably 0.7 mm or more and 3 mm or less. By setting the average diameter of the through holes 121 to be equal to or greater than the above-described lower limit value, the gas permeability of the porous plate 120 can be improved. By setting the average diameter of the through holes 121 to be equal to or less than the above-described upper limit value, the rigidity of the porous plate 120 can be improved. By setting the average diameter of the through hole 121 to be equal to or less than the above-described upper limit value described above, when there is a difference between the pressure applied to the first surface 110a of the separation membrane 110 and the pressure applied to the second surface 110b, it is possible to prevent the separation membrane 110 from being bent and dropping into the through hole 121.

An average value of thicknesses of the porous plate 120 at a plurality of positions on the X-Y plane is defined as an “average thickness” of the porous plate 120. In the embodiment, the average thickness of the porous plate 120 is greater than the average thickness of the separation membrane 110. The average thickness of the porous plate 120 is not particularly limited, and is preferably 0.01 mm or more and 50 mm or less, more preferably 0.05 mm or more and 30 mm or less, and still more preferably 0.1 mm or more and 5 mm or less. By setting the average thickness of the porous plate 120 to be equal to or greater than the above-described lower limit value, deformation of the porous plate 120 can be reduced when the pump 160 reduces the pressure in the accommodation space 130s. By setting the average thickness of the porous plate 120 to be equal to or less than the above-described upper limit value, it is possible to reduce a pressure loss when the permeation gas G2 flows through the through holes 121 of the porous plate 120.

A material for the porous plate 120 is a ceramic material, a metal material, or the like. Examples of the ceramic material include alumina. Examples of the metal material include stainless steel, titanium, and aluminum. A configuration of the porous plate is not limited to the above. The porous plate may not be provided in the separation device.

Next, the accommodation portion 130 will be described.

As illustrated in FIGS. 1 and 2, the accommodation portion 130 is a chamber. In the embodiment, the accommodation portion 130 has a hollow cylindrical shape. A central axis Cl of the accommodation portion 130 extends in the Z-axis direction. The accommodation portion 130 is formed with an inlet 130a through which the permeation gas G2 flows in and an outlet 130b through which the permeation gas G2 flows out.

Specifically, the accommodation portion 130 includes a first wall portion 131 in which the inlet 130a is formed, a second wall portion 132 located below the first wall portion 131 and in which the outlet 130b is formed, and a side wall portion 133 located between the first wall portion 131 and the second wall portion 132. The first wall portion 131 and the second wall portion 132 have a flat plate shape substantially parallel to the X-Y plane. Shapes of the first wall portion 131 and the second wall portion 132 when viewed from the top are circular. The side wall portion 133 has a cylindrical shape and extends in the Z-axis direction. An upper end of the side wall portion 133 is coupled to an outer circumferential portion of the first wall portion 131 over an entire circumference. A lower end of the side wall portion 133 is coupled to an outer circumferential portion of the second wall portion 132 over an entire circumference.

The accommodation space 130s is an internal space of the accommodation portion 130 formed by the first wall portion 131, the second wall portion 132, and the side wall portion 133. In the embodiment, the accommodation space 130s has a cylindrical shape.

The inlet 130a penetrates the first wall portion 131 in the thickness direction at substantially a center when viewed from the top. A shape of the inlet 130a when viewed from the top is, for example, circular. A step 130c in which the porous plate 120 can be disposed is formed around the inlet 130a on an upper surface of the first wall portion 131. The porous plate 120 is disposed on the step 130c so as to cover the inlet 130a.

The outlet 130b penetrates the second wall portion 132 in the thickness direction at substantially a center when viewed from the top. A shape of the outlet 130b when viewed from the top is, for example, substantially similar to an outer shape of the pipe 150 described later, and is circular.

A specific shape of the accommodation portion is not limited to the above. For example, the shape of the accommodation portion may be a hollow rectangular parallelepiped. For example, it is not necessary to form a step in the first wall portion to dispose the porous plate. The shapes of the inlet, the accommodation space, and the outlet are not limited to those described above. For example, the shape of the inlet and the outlet when viewed from the top may be a polygon such as a rectangle. For example, the shape of the accommodation space may be a rectangular parallelepiped. Positions of the inlet and the outlet are not limited to the above as long as the permeation gas can flow into the accommodation space and the permeation gas flowing into the accommodation space can be discharged to the pipe.

Next, the fixing member 140 will be described.

As illustrated in FIGS. 1 and 2, the fixing member 140 has a frame shape in the embodiment. The fixing member 140 is fixed to the accommodation portion 130 by a plurality of fixing tools 141 such as screws or bolts while covering outer circumferential portions of the separation membrane 110 and the porous plate 120 from above. Accordingly, the accommodation portion 130 holds the separation membrane 110 and the porous plate 120. At this time, although not illustrated, it is preferable to dispose a seal member so that the gas does not leak from a gap between the separation membrane 110 and the fixing member 140, a gap between the fixing member 140 and the accommodation portion 130, or the like. A specific shape of the fixing member is not limited to the above as long as the separation membrane can be fixed to the accommodation portion. A method for fixing the separation membrane and the porous plate to the accommodation portion is not limited to a method using the fixing member.

Next, the pipe 150 will be described.

The pipe 150 has a cylindrical shape and extends linearly in the Z-axis direction in the embodiment. Therefore, an internal space 151 of the pipe 150 also extends linearly in the Z-axis direction. An upper end portion of the pipe 150 is inserted into the outlet 130b, and the upper end of the pipe 150 is substantially flush with an upper surface of the second wall portion 132 of the accommodation portion 130. The internal space 151 of the pipe 150 communicates with the accommodation space 130s. A diameter D1 of an upper end portion of the internal space 151 gradually decreases from upstream to downstream.

A specific shape of the pipe is not limited to the above. For example, the pipe may be bent. The diameter of the upper end portion of the pipe may be constant without changing from upstream to downstream. Instead of inserting the upper end portion of the pipe into the outlet, the pipe may be coupled to the outlet at the second wall portion of the accommodation portion such that the upper end of the pipe is in contact with a lower surface of the second wall portion.

An arithmetic average roughness of a surface of the porous plate 120 on which the through holes 121 are formed and inner surfaces of the accommodation portion 130 and the pipe 150 is referred to as “surface roughness”. The surface roughness is not particularly limited, and is preferably 0.012 μm or more and 6.3 μm or less, more preferably 0.05 μm or more and 6.3 μm or less, and still more preferably 0.1 μm or more and 1.6 μm or less. By setting the surface roughness to be equal to or less than the above-described the upper limit value, it is possible to reduce a pressure loss when the permeation gas G2 flows through the plurality of through holes 121, the accommodation space 130s, and the internal space 151. By setting the surface roughness to be equal to or greater than the above-described lower limit value, production cost of the porous plate 120, the accommodation portion 130, and the pipe 150 can be reduced. The surface roughness is measured according to JIS B 0601: 2013 using a contact type or non-contact type surface roughness measuring instrument.

Next, the pump 160 will be described.

The pump 160 is coupled to a lower end portion of the pipe 150. The pump 160 reduces a pressure in the accommodation space 130s via the pipe 150. The pump 160 is, for example, a dry vacuum pump. A type of the pump is not particularly limited as long as the pressure in the accommodation space can be reduced to a desired pressure as described later.

Next, flows of the supply gas G1 and the permeation gas G2 will be described.

First, as illustrated in FIG. 2, the supply gas G1 is supplied to the first surface 110a of the separation membrane 110. When a pressure in the accommodation space 130s is reduced by the pump 160, a part of the carbon dioxide gas and the nitrogen gas in the supply gas G1 permeates the separation membrane 110. The permeation gas G2 containing the carbon dioxide gas and nitrogen gas that permeates the separation membrane 110 permeates the plurality of through holes 121 of the porous plate 120. Next, the permeation gas G2 flows into the internal space 151 of the pipe 150 via the accommodation space 130s. Next, the permeation gas G2 is drawn and collected by the pump 160.

Therefore, in the embodiment, a flow path FP of the permeation gas G2 between the separation membrane 110 and the pump 160 is implemented by the plurality of through holes 121 of the porous plate 120, the accommodation space 130s, and the internal space 151 of the pipe 150.

In the embodiment, a portion from the separation membrane 110 to the flow path FP allowing the accommodation space 130s of the accommodation portion 130 and the internal space 151 of the pipe 150 to communicate is linearly formed. That is, when the pump 160 is removed from the separation device 100 and the internal space 151 of the pipe 150 is viewed from below, the porous plate 120 and the separation membrane 110 can be visually recognized. Since the flow path FP has a linear shape in this manner, a pressure loss when the permeation gas G2 flows through the flow path FP can be reduced.

In the embodiment, when viewed from the top, a center of the separation membrane 110, a center of the porous plate 120, the central axis Cl of the accommodation space 130s, and a center of the internal space 151 of the pipe 150 are located at substantially the same position. Therefore, a pressure loss when the permeation gas G2 flows through the flow path FP can be reduced as compared with when the positions of these centers are offset from each other.

In the embodiment, the upper end portion of the internal space 151 is a portion of the flow path FP where the permeation gas G2 flows from the accommodation portion 130 into the pipe 150. Hereinafter, the upper end portion of the internal space 151 is also referred to as an “inlet portion FP11” of the flow path FP. As described above, the diameter D1 of the inlet portion FP11 gradually decreases from upstream to downstream. Accordingly, the permeation gas G2 gradually contracts when flowing from the accommodation portion 130 into the pipe 150. Therefore, it is possible to reduce a pressure loss when the permeation gas G2 flows from the accommodation portion 130 into the pipe 150. When a tip of the pipe is in contact with the lower surface of the second wall portion of the accommodation portion, the outlet of the accommodation portion corresponds to the inlet portion. Therefore, in this case, a similar effect can be obtained by gradually reducing a diameter of the outlet from upstream to downstream. The diameter of the inlet portion may be substantially constant from upstream to downstream.

Next, parameters of the separation device 100 will be described.

The carbon dioxide gas permeability of the separation membrane 110 is denoted by A. The nitrogen gas permeability of the separation membrane 110 is denoted by B. “Permeability” is an amount of substance of a gas that permeates per unit area, unit time, and unit pressure. The carbon dioxide gas permeability A and the nitrogen gas permeability B are measured using a gas permeability measuring device in accordance with the gas permeability test method (Part 1: differential-pressure method) specified in JIS K 7126-1:2006. Examples of the gas permeability measuring device include GTR-11A/31A manufactured by GTR TEC Corporation. A unit of the carbon dioxide gas permeability A and the nitrogen gas permeability B is, for example, GPU. 1 GPU is 3.35×10⁻¹⁰ mol·m⁻²·s⁻¹·Pa⁻¹. Thus, the carbon dioxide gas permeability A of the separation membrane 110 and the nitrogen gas permeability B of the separation membrane 110 indicate performance of the separation membrane 110 alone when not being incorporated in the separation device 100.

In the embodiment, 500,000 GPU≥A≥1,000 GPU. It is more preferable to satisfy 400,000 GPU≥A≥5,000 GPU, and it is still more preferable to satisfy 300,000 GPU≥A≥7,000 GPU. By setting the carbon dioxide gas permeability A to be equal to or greater than the above-described lower limit value, it is possible to reduce an input amount of energy required for separation. The input amount of energy required for separation is specifically a difference between a pressure applied to the first surface 110a of the separation membrane 110 and a pressure applied to the second surface 110b. In the separation membrane 110 including the resin layer 112 made of a polymer material, there is a trade-off between the carbon dioxide gas permeability A and selectivity of the separation membrane 110. Therefore, when the carbon dioxide gas permeability A exceeds the above-described upper limit value, it may be difficult to maintain a balance with the selectivity of the separation membrane 110.

The carbon dioxide gas permeability A of the separation membrane 110 can be controlled by adjusting the material for the resin layer 112, the average diameter of the pores 113h of the porous body 111, the average thickness of the porous body 111, and the like. Specifically, the carbon dioxide gas permeability A of the separation membrane 110 can be increased by using a material having a high affinity for carbon dioxide molecules as the material for the resin layer 112. The carbon dioxide gas permeability A of the separation membrane 110 can be increased by using a material having high gas permeability as the material for the porous body 111. The carbon dioxide gas permeability A of the separation membrane 110 can be increased by increasing the average diameter of the pores 113h of the porous body 111. The carbon dioxide gas permeability A of the separation membrane 110 can be increased by reducing the average thickness of the porous body 111. The inventors of the present application confirm that the separation membrane 110 having 500,000 GPU≥A≥1,000 GPU can be implemented by configuring the material for the resin layer 112, the average diameter of the pores 113h of the porous body 111, the average thickness of the porous body 111, and the like as described in the description of the separation membrane 110.

As shown (Formula 1) below, a ratio of the carbon dioxide gas permeability A to the nitrogen gas permeability B is defined as the selectivity ratio of the separation membrane 110.

$$Selectivity ratio of separation membrane 110 = A / B \qquad ( Formula 1 )$$

Hereinafter, the selectivity of the separation membrane 110 is also referred to as “selectivity A/B”. The carbon dioxide gas permeability A is greater than the nitrogen gas permeability B. Therefore, the selectivity ratio A/B of the separation membrane 110 is greater than 1.

As a result of intensive studies, the inventors of the present application find that even when the separation membrane 110 having good selectivity A/B is incorporated in the separation device 100, selectivity of the separation device 100 significantly decreases relative to the selectivity A/B of the separation membrane 110 depending on a pressure reduction amount of the pump 160. A reason for this estimation will be described below.

A partial pressure of the carbon dioxide gas in the supply gas G1 is p1. A partial pressure of the carbon dioxide gas in the permeation gas G2 in the accommodation space 130s is p2. In this case, it is considered that the carbon dioxide gas permeates the separation membrane 110 when the following (Formula 2) is satisfied.

$$p 1 > p 2 \qquad ( Formula 2 )$$

Here, a total pressure of the supply gas G1 is P1, and a total pressure of the permeation gas G2 in the accommodation space 130s is P2. A concentration of the carbon dioxide gas in the supply gas G1 is c1, and a concentration of the carbon dioxide gas in the permeation gas G2 in the accommodation space 130s is c2. At this time, since p1=P1·c1 and p2=P2·c2, (Formula 2) can be transformed into (Formula 3) below.

$$P 1 \cdot c 1 > P 2 \cdot c 2 \qquad ( Formula 3 )$$

When Formula 3 is further transformed, the following Formula 4 is obtained.

$$( P 1 / P 2 ) > ( c 2 / c 1 ) \qquad ( Formula 4 )$$

c2/c1 is a magnification of the concentration c2 of the carbon dioxide gas that permeates the separation membrane 110 to the concentration c1 of the carbon dioxide gas supplied to the separation membrane 110. Therefore, hereinafter, c2/c1 is also referred to as a “concentration magnification c2/c1”. The higher the concentration magnification c2/c1, the larger an amount of carbon dioxide gas collected by the separation device 100. It can be seen from Formula 4 that the concentration magnification c2/c1 is smaller than a ratio of the total pressure P1 of the supply gas G1 to the total pressure P2 of the permeation gas G2. Hereinafter, P1/P2 is also referred to as a “total pressure ratio P1/P2”.

Theoretically, the concentration magnification c2/c1 is smaller than the selectivity A/B. Therefore, when the total pressure ratio P1/P2 is smaller than the selectivity A/B of the separation membrane 110, an upper limit of the concentration magnification c2/c1 becomes a value (total pressure ratio P1/P2) lower than the selectivity A/B of the separation membrane 110 selected when incorporated into the separation device 100. Meanwhile, when the total pressure ratio P1/P2 is equal to or greater than the selectivity A/B of the separation membrane 110, the upper limit of the concentration magnification c2/c1 becomes the selectivity A/B of the separation membrane 110 selected when incorporated into the separation device 100. That is, when the total pressure ratio P1/P2 is equal to or greater than the selectivity A/B of the separation membrane 110, the concentration magnification c2/c1 can be made higher than when the total pressure ratio P1/P2 is smaller than the selectivity A/B of the separation membrane 110.

Therefore, it is considered that the concentration magnification c2/c1 of the separation device 100 can be increased if the following (Formula 5) is satisfied.

$$( P 1 / P 2 ) \geq ( A / B ) \qquad ( Formula 5 )$$

By transforming Formula 5, the following Formula 6 is obtained.

$$( P 1 / P 2 ) / ( A / B ) \geq 1 \qquad ( Formula 6 )$$

The total pressure ratio P1/P2 can be controlled by adjusting the pressure reduction amount of the pump 160. Specifically, the more the pump 160 reduces the pressure in the accommodation space 130s, the lower the total pressure P2 becomes and the larger the total pressure ratio P1/P2 becomes.

As the total pressure ratio P1/P2 increases, energy required to drive the pump 160 increases. As the total pressure ratio P1/P2 increases, the difference between the pressure applied to the first surface 110a of the separation membrane 110 and the pressure applied to the second surface 110b increases. As a result, a period until the separation membrane 110 is damaged by repeated or continuous application of pressure, that is, a life of the separation membrane 110 is shortened. Therefore, although not particularly limited, 15≥(P1/P2)/(A/B) is preferable.

Here, a method for measuring the total pressures P1 and P2 will be described. As illustrated in FIG. 2, for example, a pressure gauge PS1 such as a barometer is disposed outside the separation device 100 and around the separation membrane 110. For example, a pressure gauge PS2 such as a gauge pressure gauge is disposed in a through hole formed in the accommodation portion 130. The total pressure P1 of the supply gas G1 can be obtained as an absolute pressure by a pressure gauge PS1. The total pressure P2 of the permeation gas G2 can be obtained as a sum (absolute pressure) of a gauge pressure measured by the pressure gauge PS2 and an atmospheric pressure. A type of the pressure gauge used for measuring the total pressure P1 of the supply gas G1 and the total pressure P2 of the permeation gas G2 is not particularly limited as long as the total pressures P1 and P2 are finally obtained as absolute pressures.

As described above, depending on the pressure reduction amount of the pump 160, it is considered that there may be cases where (Formula 6) is not satisfied, and the concentration magnification c2/c1 significantly decreases. The decrease in the concentration magnification c2/c1 means that the carbon dioxide gas permeability of the separation device 100 decreases. Therefore, it is considered that the selectivity of the separation device 100 may be significantly reduced relative to the selectivity A/B of the separation membrane 110.

However, as a result of further studies by the inventors of the present application, it is found that even when the separation device 100 is configured to satisfy (Formula 6), the selectivity of the separation device 100 is still significantly reduced relative to the selectivity A/B of the separation membrane 110. It is considered that this is because, by configuring the separation device 100 so as to satisfy (Formula 6), a flow rate and a flow velocity of the permeation gas G2 increase, a pressure loss of the flow path FP between the separation membrane 110 and the pump 160 increases, and the permeation gas G2 becomes difficult to flow. Therefore, the inventors of the present application consider that it is important to further consider not only the total pressure ratio P1/P2 but also gas permeability of the flow path FP.

FIG. 4 is a schematic diagram illustrating a method for measuring the gas permeability of the flow path FP in the embodiment. In the drawing, some pipes are simplified and indicated by solid lines.

A gas permeability measuring device 10 is used to measure the gas permeability of the flow path FP. The gas permeability measuring device 10 includes a gas supply part 11, an upstream pressure gauge 12, a downstream pressure gauge 13, a flowmeter 14, a vacuum pump 15, and a concentration meter 16. First, the porous plate 120, the accommodation portion 130, and the pipe 150, which are portions forming the flow path FP in the separation device 100, are disposed between the gas supply part 11 and the vacuum pump 15. The gas supply part 11 and an inlet of the flow path FP are coupled by a pipe or the like. An outlet of the flow path FP and the vacuum pump 15 are coupled by a pipe or the like.

The gas supply part 11 is implemented with, for example, a gas tank and a mass flow controller. A gas supplied by the gas supply part 11 is a gas as a main component of the permeation gas G2. In the embodiment, the supply gas G1 is the atmosphere, and a concentration and a partial pressure of the nitrogen gas in the supply gas G1 are much higher than a concentration and a partial pressure of the carbon dioxide gas. Therefore, although the carbon dioxide gas permeability A of the separation membrane 110 is higher than the nitrogen gas permeability B, a permeation amount of the nitrogen gas is larger than a permeation amount of the carbon dioxide gas. That is, in the embodiment, the gas as the main component of the permeation gas G2 is the nitrogen gas. Therefore, the gas supply part 11 supplies a single gas, which is nitrogen gas. When the supply gas is not the atmosphere and the concentration and the partial pressure of the carbon dioxide gas in the supply gas are higher than the concentration and the partial pressure of the nitrogen gas, the gas as the main component of the permeation gas is the carbon dioxide gas. In this case, the gas supply part may supply the carbon dioxide gas.

When measuring the gas permeability of the flow path FP, first, the vacuum pump 15 reduces a pressure in the flow path FP to 3 kPa. Next, the gas supply part 11 supplies a gas to the inlet of the flow path FP at 103 kPa. In the embodiment, the inlet of the flow path FP is the porous plate 120. Accordingly, the gas starts to flow through the flow path FP. Then, the vacuum pump 15 draws in the gas that permeates the flow path FP. At this time, an absolute pressure of the gas supplied to the inlet of the flow path FP is measured by the upstream pressure gauge 12. An absolute pressure of the gas that permeates the outlet of the flow path FP is measured by the downstream pressure gauge 13. A volume of the gas that permeates the outlet of the flow path FP per unit time is measured by the flowmeter 14. An amount of substance per unit volume of the gas collected by the vacuum pump 15 is measured by the concentration meter 16. Other test conditions such as a test temperature are in accordance with JIS K 7126-1: 2006 as much as possible.

Immediately after supply of the gas, a flow rate of the gas that permeates the flow path FP and the absolute pressure downstream of the flow path FP gradually increase, and then a stable state is reached where the flow rate and the absolute pressure remain substantially constant. In the stable state, an upstream absolute pressure is P3, and a downstream absolute pressure is P4. An amount of substance per unit time of the gas that permeates the outlet of the flow path FP is calculated based on a volume per unit time of the gas and an amount of substance per unit volume of the gas in the stable state. The amount of substance per unit time is defined as n. An area of the inlet of the flow path FP to which the gas is supplied is defined as s1. In the embodiment, the area s1 of the inlet of the flow path FP to which the gas is supplied corresponds to an area of an upper surface of the porous plate 120.

The gas permeability of the flow path FP is C. The gas permeability C of the flow path FP can be calculated by substituting the above values into (Formula 7) below.

$$C = n / \{ ( P 3 - P 4 ) \cdot s 1 \} \qquad ( Formula 7 )$$

A unit of the above-described gas permeability C is mol·m⁻²·s⁻¹·Pa⁻¹. The gas permeability C is used together with the carbon dioxide gas permeability A and the nitrogen gas permeability B for calculation of parameters to be described later. Therefore, the unit of the gas permeability C needs to be the same as the unit of the carbon dioxide gas permeability A and the nitrogen gas permeability B. When the GPU is used as the unit of the carbon dioxide gas permeability A and the nitrogen gas permeability B, a value calculated by (Formula 7) may be divided by 3.35×10⁻¹⁰. Since the gas permeability C is measured using the gas as the main component of the permeation gas G2, it can be regarded as the permeability of the permeation gas G2 in the flow path FP. The gas permeability measuring device 10 may also be used to measure the carbon dioxide gas permeability A and the nitrogen gas permeability B. In this case, similarly to JIS K 7126-1: 2006, in a state where the separation membrane 110 is installed in a chamber, an upstream side of the chamber and the gas supply part 11 may be coupled by a pipe, and a downstream side of the chamber and the vacuum pump 15 may be coupled by a pipe. When the carbon dioxide gas permeability A is measured, the gas supply part 11 supplies a single gas, which is a carbon dioxide gas, and when the nitrogen gas permeability B is measured, the gas supply part 11 supplies a single gas, which is a nitrogen gas.

Theoretically, when two gas permeable bodies are disposed in series, gas permeability of an upstream gas permeable body is x and gas permeability of a downstream gas permeable body is y, total gas permeability z of the combined two gas permeable bodies is considered to be represented by (Formula 8) below.

$$1 / z = 1 / x + 1 / y \qquad ( Formula 8 )$$

By transforming (Formula 8), the following (Formula 9) is obtained.

$$z = ( xy ) / ( x + y ) \qquad ( Formula 9 )$$

The separation membrane 110 can be regarded as the upstream gas permeable body, and the flow path FP can be regarded as the downstream gas permeable body. Therefore, when the carbon dioxide gas permeability of the separation device 100 is z1, the carbon dioxide gas permeability z1 of the separation device 100 is considered to be represented by the following (Formula 10) by combining the carbon dioxide gas permeability A of the separation membrane 110 and the gas permeability C of the flow path FP.

$$z 1 = ( A C ) / ( A + C ) \qquad ( Formula 10 )$$

Similarly, when the nitrogen gas permeability of the separation device 100 is z2, the nitrogen gas permeability z2 of the separation device 100 is considered to be represented by the following (Formula 11).

$$z 2 = ( BC ) / ( B + C ) \qquad ( Formula 11 )$$

The selectivity of the separation device 100 is α. Based on (Formula 10) and (Formula 11), the selectivity α of the separation device 100 is considered to be represented by the following (Formula 12).

$$α = z 1 / z 2 + \{ ( B + C ) / ( A + C ) \} \cdot ( A / B ) \qquad ( Formula 12 )$$

Based on Formula 12, the selectivity α of the separation device 100 is considered to be obtained by multiplying the selectivity A/B of the separation membrane 110 by (B+C)/(A+C). Therefore, (B+C)/(A+C) can be regarded as a magnification of selectivity.

Hereinafter, (B+C)/(A+C) is also referred to as “magnification of selectivity (B+C)/(A+C)”. In the magnification of selectivity (B+C)/(A+C), the carbon dioxide gas permeability A and the nitrogen gas permeability B are determined by performance of the separation membrane 110 incorporated in the separation device 100. The nitrogen gas permeability B is smaller than the carbon dioxide gas permeability A. Therefore, the magnification of selectivity (B+C)/(A+C) is to be less than 1 regardless of a value of the gas permeability C of the flow path FP. As the value of the gas permeability C of the flow path FP increases, an influence of magnitudes of values of the carbon dioxide gas permeability A and the nitrogen gas permeability B can be reduced, and the magnification of selectivity (B+C)/(A+C) approaches 1.

Therefore, in order to increase the selectivity a of the separation device 100, it is important to increase the gas permeability C of the flow path FP. When only an influence of the gas permeability C is considered, it is considered that the selectivity α of the separation device 100 can be set to be less than 100% and equal to or greater than 80% of the selectivity A/B of the separation membrane 110 by designing the flow path FP of the separation device 100 so as to satisfy the following (Formula 13).

$$1 > ( B + C ) / ( A + C ) \geq 0.8 \qquad ( Formula 13 )$$

Actually, even when the above (Formula 13) is satisfied, the selectivity α of the separation device 100 may not be equal to or greater than 80% of the selectivity A/B of the separation membrane 110 due to other factors such as an insufficient pressure reduction amount of the pump 160 described above. Thus, (B+C)/(A+C) does not necessarily correspond to the magnification of selectivity, but (B+C)/(A+C) is also referred to as the magnification of selectivity in the following description for easy understanding of the description.

The gas permeability C of the flow path FP can be increased by reducing a pressure loss of the flow path FP. The pressure loss of the flow path FP can be adjusted by, for example, an area of the separation membrane 110 when viewed from the top, a length of the flow path FP, surface roughness of the flow path FP, and the number of bent portions of the flow path FP. The pressure loss decreases as the length of the flow path FP decreases. The length of the flow path FP can be adjusted by, for example, a thickness of the porous plate 120, a length from the inlet 130a to the outlet 130b of the accommodation space 130s, and a length of the pipe 150. The pressure loss decreases as the surface roughness of the flow path FP decreases. In the embodiment, the surface roughness of the flow path FP can be adjusted by surface roughness of the surface of the porous plate 120 on which the through holes 121 are formed and surface roughness of the inner surfaces of the accommodation portion 130 and the pipe 150. The pressure loss decreases as the number of bent portions of the flow path FP decreases. The number of bent portions of the flow path FP can be adjusted by a shape of the accommodation space 130s of the accommodation portion 130 and the internal space 151 of the pipe 150.

In the flow path FP, when there is a portion where the permeation gas G2 contracts, the pressure loss decreases as a contraction ratio decreases. In the embodiment, when the permeation gas G2 flows from the accommodation space 130s into the internal space of the pipe 150, the permeation gas G2 contracts. Therefore, the pressure loss decreases as a diameter of the internal space 151 of the pipe 150 approaches a diameter of the accommodation space 130s. The pressure loss that occurs when the permeation gas G2 gradually contracts is smaller than the pressure loss that occurs when the permeation gas G2 contracts at once. Therefore, as described above, the pressure loss can be reduced by gradually reducing the diameter D1 of the inlet portion FP11 of the flow path FP from upstream to downstream.

When there is a portion where the permeation gas G2 expands in the flow path, the pressure loss decreases as an expansion rate decreases. In the embodiment, when the permeation gas G2 flows into the accommodation space 130s from the through holes 121 of the porous plate 120, the permeation gas G2 expands. Therefore, the pressure loss decreases as the diameter of the through hole 121 of the porous plate 120 increases.

The pressure loss can be reduced by forming the shape of the accommodation space 130s into a shape having a small number of corners where the permeation gas G2 stays. In the embodiment, the accommodation space 130s has a cylindrical shape. Therefore, the pressure loss can be reduced as compared with when the accommodation space 130s has a rectangular parallelepiped or polygonal prism shape.

Thus, the inventors of the present application clarify that it is important to consider both the total pressure ratio P1/P2 and the gas permeability C of the flow path FP in order to improve the selectivity α of the separation device 100 relative to the selectivity A/B of the separation membrane 110.

Next, a method for designing the separation device 100 based on the above will be described.

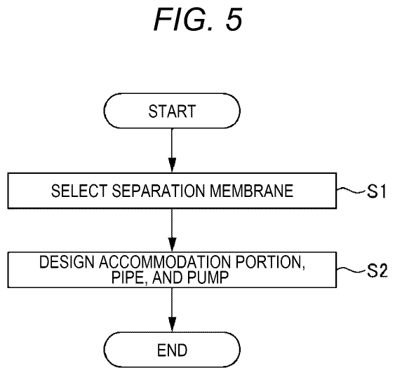

FIG. 5 is a flowchart illustrating a method for designing the separation device 100 according to the embodiment.

The method for designing the separation device 100 includes a step S1 of selecting the separation membrane 110 and a step S2 of designing the accommodation portion 130, the pipe 150, and the pump 160. Hereinafter, each step will be described in detail.

In the selecting step S1, a separation membrane satisfying 500,000 GPU≥A≥1,000 GPU is selected as the separation membrane 110 to be incorporated into the separation device 100.

In the designing step S2, a pump capable of reducing a pressure in the accommodation space 130s of the accommodation portion 130 is selected as the pump 160 to be incorporated into the separation device 100 such that (P1/P2)/(A/B)≥1 is satisfied. In the designing step S2, the flow path FP between the separation membrane 110 and the pump 160 is designed such that 1>(B+C)/(A+C)≥0.8.

Thus, values of the total pressure ratio P1/P2 and the gas permeability C of the flow path FP required for the separation device 100 are clear based on the carbon dioxide gas permeability A and the nitrogen gas permeability B of the separation membrane 110 selected in the selecting step S1. Therefore, it is easy to design the separation device 100. As a result, it is possible to easily obtain the separation device 100 having good selectivity α relative to the selectivity A/B of the separation membrane 110.

Next, effects of the embodiment will be described.

The separation device 100 is a separation device that selectively separates a carbon dioxide gas from the supply gas G1 containing the carbon dioxide gas and a nitrogen gas. The separation device 100 includes the separation membrane 110, the accommodation portion 130, the pipe 150, and the pump 160. The separation membrane 110 includes the porous body 111 and the resin layer 112 that is disposed on the porous body 111 and selectively allows the carbon dioxide gas contained in the supply gas G1 to permeate toward the porous body 111. The accommodation portion 130 holds the separation membrane 110 and is formed with the accommodation space 130s for accommodating the permeation gas G2 that permeates the separation membrane 110. The pipe 150 is coupled to the accommodation portion 130. The pump 160 reduces a pressure in the accommodation space 130s via the pipe 150 and draws in the permeation gas G2. When the carbon dioxide gas permeability of the separation membrane 110 is A, 500,000 GPU≥A≥1,000 GPU. When the nitrogen gas permeability of the separation membrane 110 is B, the total pressure of the supply gas G1 is P1, and the total pressure of the permeation gas G2 in the accommodation space 130s is P2, (P1/P2)/(A/B)≥1. The flow path FP of the permeation gas G2 between the separation membrane 110 and the pump 160 includes the accommodation space 130s and the internal space 151 of the pipe 150. When the gas permeability of the flow path FP is C, 1>(B+C)/(A+C)≥0.8.

In the separation device 100, since (P1/P2)/(A/B)≥1, the concentration magnification c2/c1 can be increased. The high concentration magnification c2/c1 means that the carbon dioxide gas permeability z1 of the separation device 100 is high. Accordingly, the selectivity α of the separation device 100 can be increased. By setting 1>(B+C)/(A+C)≥0.8, the magnification of selectivity (B+C)/(A+C) can be increased. Accordingly, it is possible to implement the separation device 100 having the good selectivity α relative to the selectivity A/B of the separation membrane 110.

15≥(P1/P2)/(A/B). Accordingly, it is possible to reduce an increase in energy required for driving the pump 160. The life of the separation membrane 110 can be prevented from being shortened.

In the flow path FP, the diameter D1 of the inlet portion FP11 through which the permeation gas G2 flows from the accommodation portion 130 into the pipe 150 gradually decreases from upstream toward downstream. Accordingly, the pressure loss when the permeation gas G2 contracts can be reduced. As a result, the gas permeability C of the flow path FP can be increased.

A portion from the separation membrane 110 to the flow path FP allowing the accommodation space 130s of the accommodation portion 130 and the internal space 151 of the pipe 150 to communicate is linearly formed. Therefore, the pressure loss when the permeation gas G2 flows through the flow path FP can be reduced. As a result, the gas permeability C of the flow path FP can be increased.

The pipe 150 extends linearly. Therefore, the pressure loss when the permeation gas G2 flows through the pipe 150 can be reduced. As a result, the gas permeability C of the flow path FP can be increased.

The porous body 111 contains a polymer material, a ceramic material, or a metal material. When the porous body 111 contains a polymer material, the gas permeability of the porous body 111 can be increased. When the porous body 111 contains a ceramic material or a metal material, mechanical strength of the porous body 111 can be increased.

The resin layer 112 contains organopolysiloxane. Accordingly, the carbon dioxide gas permeability of the resin layer 112 can be increased. As a result, the selectivity A/B of the separation membrane 110 can be increased.

The method for designing the separation device 100 is a method for designing the separation device 100 that selectively separates the carbon dioxide gas from the supply gas G1 containing the carbon dioxide gas and the nitrogen gas. The method for designing the separation device 100 includes step S1 of selecting the separation membrane 110, and step S2 of designing the accommodation portion 130, the pipe 150, and the pump 160. The separation membrane 110 includes the porous body 111 and the resin layer 112 that is disposed on the porous body 111 and allows the carbon dioxide gas contained in the supply gas G1 to permeate toward the porous body 111. The accommodation portion 130 holds the separation membrane 110 and is formed with the accommodation space 130s for accommodating the permeation gas G2 that permeates the separation membrane 110. The pipe 150 is coupled to the accommodation portion 130. The pump 160 reduces a pressure in the accommodation space 130s via the pipe 150 and draws in the permeation gas G2. The flow path FP of the permeation gas G2 between the separation membrane 110 and the pump 160 includes the accommodation space 130s and the internal space 151 of the pipe 150. In the selecting step S1, when the carbon dioxide gas permeability of the separation membrane 110 is A, the separation membrane 110 that satisfies 500,000 GPU≥A≥1,000 GPU is selected. In the designing step S2, when the nitrogen gas permeability of the separation membrane 110 is B, the total pressure of the supply gas G1 is P1, and the total pressure of the permeation gas G2 in the accommodation space 130s is P2, the pump 160 capable of reducing a pressure in the accommodation space 130s is selected such that (P1/P2)/(A/B)≥1. In the designing step S2, when the C is gas permeability of the flow path, the flow path FP is designed such that 1>(B+C)/(A+C)≥0.8.

According to the method for designing the separation device 100 described above, the designer can easily grasp the total pressure ratio P1/P2 required for the separation device 100 and the gas permeability C required for the flow path FP based on the carbon dioxide gas permeability A and the nitrogen gas permeability B of the selected separation membrane 110. Therefore, the designer can easily design the separation device 100 having the good selectivity α relative to the selectivity A/B of the separation membrane 110. Since performance required for the pump 160 and the gas permeability C required for the flow path FP are clear, when designing the separation device 100, it is possible to prevent the pump 160 having excessive performance from being selected or the pressure loss of the flow path FP from being excessively reduced. Accordingly, production cost of the separation device 100 can be reduced.

In the designing step S2, the shape of the accommodation space 130s, the inner diameter of the pipe 150, the length of the flow path FP, the surface roughness of the flow path FP, and the number of bent portions of the flow path FP are adjusted such that 1>(B+C)/(A+C)≥0.8. Accordingly, it is possible to implement the separation device 100 having the good selectivity α relative to the selectivity A/B of the separation membrane 110.

### Second Embodiment

Next, a separation device 200 according to the second embodiment will be described.

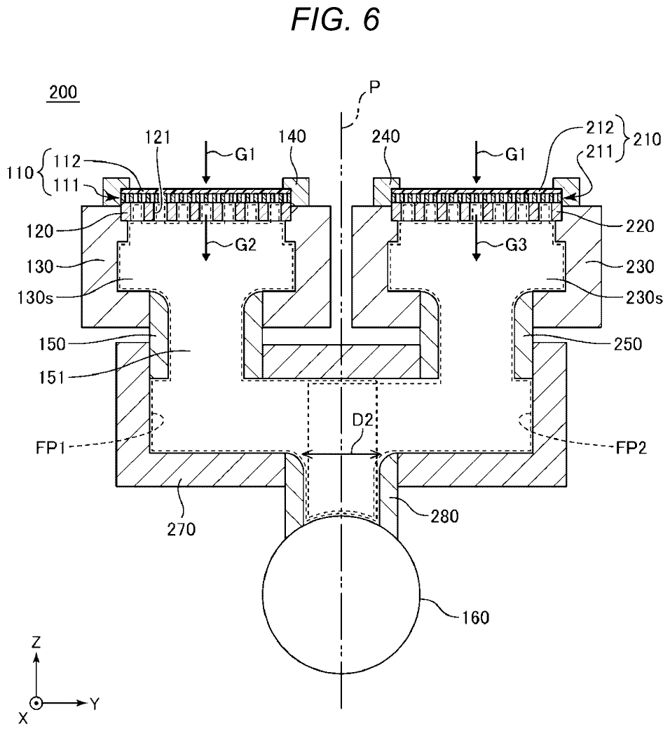

FIG. 6 is a cross-sectional view illustrating the separation device 200 according to the embodiment.

The separation device 200 is different from the separation device 100 according to the first embodiment in that the separation device 200 further includes another separation membrane 210, another porous plate 220, another accommodation portion 230, another fixing member 240, and another pipe 250. Hereinafter, differences between the second embodiment and the first embodiment will be mainly described, and description of a configuration similar as that of the first embodiment will be appropriately omitted. The same applies to a modification example described later.

The separation membrane 110 is also referred to as a “first separation membrane 110”. The porous plate 120 is also referred to as a “first porous plate 120”. The accommodation portion 130 is also referred to as a “first accommodation portion 130”. The pipe 150 is also referred to as a “first pipe 150”. The other separation membrane 210 is also referred to as a “second separation membrane 210”. The other porous plate 220 is also referred to as a “second porous plate 220”. The other accommodation portion 230 is also referred to as a “second accommodation portion 230”. The fixing member 140 is also referred to as a “first fixing member 140”. The other fixing member 240 is also referred to as a “second fixing member 240”. The other pipe 250 is also referred to as a “second pipe 250”.

The second separation membrane 210 selectively allows the carbon dioxide gas contained in the supply gas G1 to permeate. Hereinafter, the gas that permeates the second separation membrane 210 is referred to as “other permeation gas G3”. The second separation membrane 210 includes another porous body 211 and another resin layer 212 that is disposed on the other porous body 211 and selectively allows the carbon dioxide gas contained in the supply gas G1 to permeate toward the other porous body 211. The other porous body 211 is configured similarly to the porous body 111 in the first separation membrane 110. The other resin layer 212 is configured similarly to the resin layer 112 in the first separation membrane 110. Therefore, selectivity of the second separation membrane 210 is substantially the same as the selectivity A/B of the first separation membrane 110.

The second porous plate 220 is disposed below the second separation membrane 210 and supports the second separation membrane 210. The second porous plate 220 is configured similarly to the first porous plate 120.

Another accommodation space 230s for accommodating the other permeation gas G3 is formed in the second accommodation portion 230. The second accommodation portion 230 is configured similarly to the first accommodation portion 130. In the embodiment, the second accommodation portion 230 is spaced apart from the first accommodation portion 130, and the other accommodation space 230s is spaced apart from the accommodation space 130s. The first accommodation portion and the second accommodation portion may be in contact with each other, and the first accommodation portion and the second accommodation portion may be integrated as long as the accommodation space is spaced apart from the other accommodation space.

The second fixing member 240 fixes the second separation membrane 210 and the second porous plate 220 to the second accommodation portion 230. The second fixing member 240 is configured similarly to the first fixing member 140. In the embodiment, a lower end portion of the first pipe 150 is not directly coupled to the pump 160. An upper end portion of the second pipe 250 is coupled to the second accommodation portion 230. The second pipe 250 is configured similarly to the first pipe 150.

The separation device 200 further includes a third pipe 270 coupled to the lower end portion of the first pipe 150 and a lower end portion of the second pipe 250, and a fourth pipe 280 coupling the third pipe 270 and the pump 160. The third pipe 270 linearly extends from the lower end portion of the first pipe 150 toward the lower end portion of the second pipe 250. An internal space of the third pipe 270 communicates with the internal space 151 of the first pipe 150 and an internal space of the second pipe 250. The fourth pipe 280 extends in the Z-axis direction. An upper end portion of the fourth pipe 280 is coupled to a substantially center of the third pipe 270 in a longitudinal direction. An internal space of the fourth pipe 280 communicates with the internal space of the third pipe 270. A lower end portion of the fourth pipe 280 is coupled to the pump 160.

The fourth pipe 280 is coupled to the third pipe 270 such that an upper end of the fourth pipe 280 is substantially flush with an inner surface of the third pipe 270. A diameter D2 of the upper end portion of the internal space of the fourth pipe 280 gradually decreases from upstream to downstream. Accordingly, a pressure loss when the permeation gas G2 and the other permeation gas G3 flow from the third pipe 270 into the fourth pipe 280 can be reduced.

The pump 160 reduces a pressure in the accommodation space 130s via the first pipe 150, the third pipe 270, and the fourth pipe 280. The pump 160 reduces a pressure in the other accommodation space 230s via the second pipe 250, the third pipe 270, and the fourth pipe 280.

Next, a flow of the permeation gas G2 and the other permeation gas G3 of the separation device 200 will be described.

The permeation gas G2 that permeates the first separation membrane 110 passes through the first porous plate 120, the first accommodation portion 130, the first pipe 150, the third pipe 270, and the fourth pipe 280, and is drawn and collected by the pump 160. The other permeation gas G3 that permeates the second separation membrane 210 passes through the second porous plate 220, the second accommodation portion 230, the second pipe 250, the third pipe 270, and the fourth pipe 280, and is drawn and collected by the pump 160.

A flow path of the permeation gas G2 between the first separation membrane 110 and the pump 160 is referred to as a “flow path FP1”. The flow path FP1 includes the plurality of through holes 121 of the first porous plate 120, the accommodation space 130s of the first accommodation portion 130, the internal space 151 of the first pipe 150, a part of the internal space of the third pipe 270, and the internal space of the fourth pipe 280. A flow path of the other permeation gas G3 between the second separation membrane 210 and the pump 160 is referred to as “other flow path FP2”. The other flow path FP2 includes a plurality of through holes of the second porous plate 220, the other accommodation space 230s of the second accommodation portion 230, the internal space of the second pipe 250, a part of the internal space of the third pipe 270, and the internal space of the fourth pipe 280. A shape of the flow path FP1 and a shape of the other flow path FP2 are substantially plane-symmetrical with respect to a plane P located between the first accommodation portion 130 and the second accommodation portion 230 and parallel to a Z-X plane.

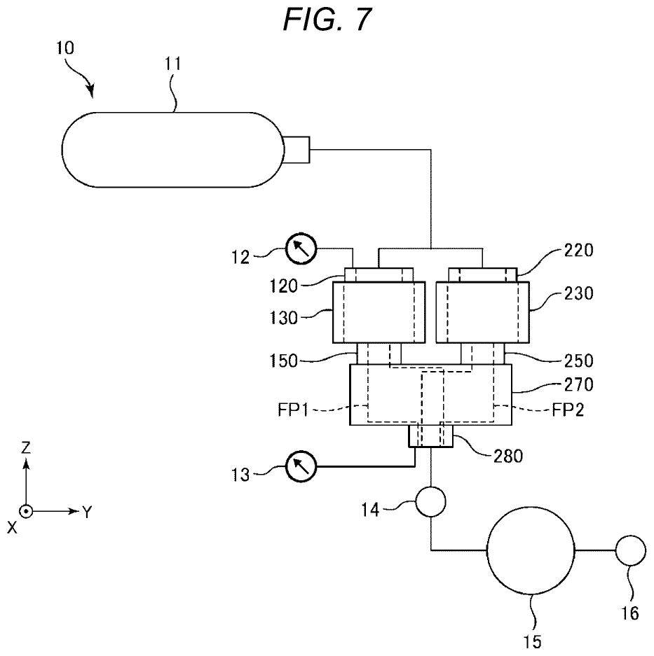

FIG. 7 is a schematic diagram illustrating a method for measuring the gas permeability C of the flow path FP1 in the embodiment. In the drawing, some pipes are simplified and indicated by solid lines.

First, both a portion forming the flow path FP1 and a portion forming the other flow path FP2 in the separation device 200 are disposed between the gas supply part 11 and the vacuum pump 15 of the gas permeability measuring device 10. That is, the first porous plate 120, the first accommodation portion 130, the first pipe 150, the second porous plate 220, the second accommodation portion 230, the second pipe 250, the third pipe 270, and the fourth pipe 280 are disposed between the gas supply part 11 and the vacuum pump 15. The gas supply part 11 is coupled to the inlet of the flow path FP1, and the gas supply part 11 is coupled to an inlet of the other flow path FP2 by piping. Outlets of the flow path FP1 and the other flow path FP2 are coupled to the vacuum pump 15 by piping.

Next, pressures in the flow path FP1 and the other flow path FP2 are reduced by the vacuum pump 15. Next, the gas supply part 11 supplies a gas to the inlets of the flow path FP1 and the other flow path FP2. The vacuum pump 15 draws in the gas that permeates the flow path FP1 and the other flow path FP2. At this time, an absolute pressure of the gas supplied to the inlet of the flow path FP1 or the other flow path FP2 is measured by the upstream pressure gauge 12. An absolute pressure of the gas that permeates the outlet of the flow path FP1 and the other flow path FP2 is measured by the downstream pressure gauge 13. A volume of the gas that permeates the outlet of the flow path FP1 and the other flow path FP2 per unit time is measured by the flowmeter 14. An amount of substance per unit volume of the gas collected by the vacuum pump 15 is measured by the concentration meter 16.

A sum of an area of the inlet of the flow path FP1 to which the gas is supplied and an area of the inlet of the other flow path FP2 to which the gas is supplied is defined as s1. In the embodiment, the area s1 corresponds to a sum of an area of the upper surface of the first porous plate 120 and an area of an upper surface of the second porous plate 220. As in the first embodiment, the gas permeability C can be calculated by substituting the upstream absolute pressure P3, the downstream absolute pressure P4, the amount of substance n per unit time, and the area s1 into (Formula 7).

The gas permeability C represents an amount of substance of a gas that permeates per unit time, unit pressure, and unit area. As described above, the shape of the flow path FP1 and the shape of the other flow path FP2 are substantially symmetrical. Therefore, the calculated gas permeability C may be the gas permeability of the flow path FP1, or may be the gas permeability of the other flow path FP2. When there are a plurality of flow paths and it is assumed that gas permeability of the plurality of flow paths is different from each other, the above-described measurement method may be performed when a flow path other than the flow path to be measured is closed.

In the embodiment, the first separation membrane 110 and the second separation membrane 210 are similarly configured. Therefore, when 500,000 GPU≥A≥1,000 GPU, (P1/P2)/(A/B)≥1, and 1>(B+C)/(A+C)≥0.8 are satisfied, it is possible to obtain the separation device 200 having the good selectivity α relative to the selectivity A/B of both the first separation membrane 110 and the second separation membrane 210.

When the separation device includes a plurality of separation membranes and the selectivity of the plurality of separation membranes is different from each other, it is preferable that all the separation membranes satisfy the three inequalities described above. When the above three inequalities are established with respect to the selectivity of at least one separation membrane, a separation device having good selectivity relative to the selectivity of at least one separation membrane can be obtained. The number of separation membranes provided in the separation device may be three or more.

The separation device 200 according to the embodiment further includes the other separation membrane 210, the other accommodation portion 230, and the other pipe 250. The other separation membrane 210 includes the other porous body 211 and the other resin layer 212 that is disposed on the other porous body 211 and selectively allows the carbon dioxide gas contained in the supply gas G1 to permeate toward the other porous body 211. The other accommodation portion 230 holds the other separation membrane 210 and is formed with the other accommodation space 230s for accommodating the other permeation gas G3 that permeates the other separation membrane 210. The other pipe 250 is coupled to the other accommodation portion 230. The pump 160 reduces a pressure in the other accommodation space 230s via the other pipe 250. Accordingly, a flow path from the separation membrane 110 to the pipe 150 and a flow path from the other separation membrane 210 to the other pipe 250 can be separated. Therefore, the separation device 200 can reduce a pressure loss as compared with when the permeation gas of the plurality of separation membranes flows into one accommodation portion and one pipe.

### Modification Example 1

Next, a separation membrane 310 according to Modification Example 1 will be described.

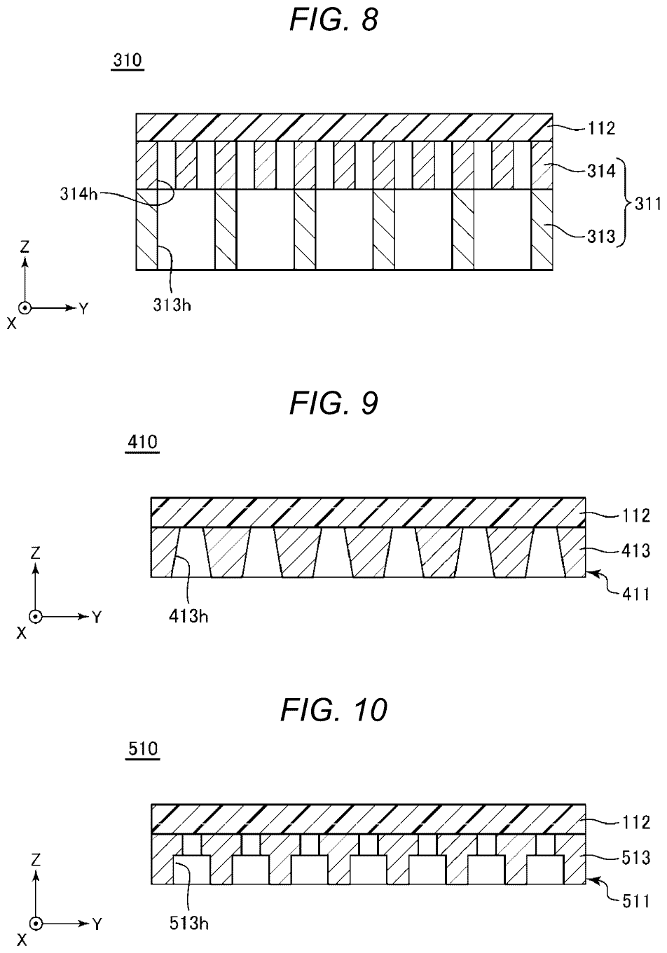

FIG. 8 is a cross-sectional view illustrating the separation membrane 310 according to the modification example.

The separation membrane 310 is different from the separation membrane 110 in the first embodiment in that a porous body 311 includes a plurality of stacked porous layers 313 and 314.

A plurality of pores 313h are formed in the porous layer 313. The pores 313h penetrate the porous layer 313 in the thickness direction. The plurality of pores 313h are dispersedly formed at the X-Y plane. The porous layer 314 is disposed on the porous layer 313. The resin layer 112 is disposed on the porous layer 314. A plurality of pores 314h are formed in the porous layer 314. The pores 314h penetrate the porous layer 314 in the thickness direction. The plurality of pores 314h are dispersedly formed at the X-Y plane. A diameter of the pore 313h is larger than a diameter of the pore 314h.

That is, the pores 313h and 314h penetrating the plurality of porous layers 313 and 314 in the thickness direction are formed in the plurality of porous layers 313 and 314. The pores 313h of the porous layer 313 farther away from the resin layer 112 have a larger diameter. Accordingly, a flow of the carbon dioxide gas that permeates the resin layer 112 gradually expands when permeating the porous body 311 and reaches the accommodation space 130s. Therefore, a pressure loss can be reduced. Since the pore 314h of the porous layer 314 closer to the resin layer 112 have a smaller diameter, the porous body 311 can favorably support the resin layer 112. Accordingly, it is possible to increase mechanical strength of the separation membrane 310.

### Modification Example 2

Next, a separation membrane 410 according to Modification Example 2 will be described.

FIG. 9 is a cross-sectional view illustrating the separation membrane 410 according to the modification example.

The separation membrane 410 is different from the separation membrane 110 in the first embodiment in a shape of pores 413h formed in a porous body 411.

The porous body 411 includes a porous layer 413 that supports the resin layer 112. The porous layer 413 has the pores 413h penetrating the porous layer 413 in the thickness direction. A diameter of the pore 413h continuously increases in a direction from the resin layer 112 toward the porous layer 413. That is, the shape of the pore 413h is a frustum. Accordingly, a flow of the carbon dioxide gas that permeates the resin layer 112 gradually expands when permeating the porous body 411 and reaches the accommodation space 130s. Therefore, a pressure loss can be reduced. In the porous layer 413, the closer to the resin layer 112 a portion is, the smaller the diameter of the pore 413h is, so that the porous layer 413 can favorably support the resin layer 112. Accordingly, it is possible to increase mechanical strength of the separation membrane 410.

### Modification Example 3

Next, a separation membrane 510 according to Modification Example 3 will be described.

FIG. 10 is a cross-sectional view illustrating the separation membrane 510 according to the modification example.

The separation membrane 510 is different from the separation membrane 410 in Modification Example 2 in a shape of the pores 513h formed in a porous body 511.

The porous body 511 includes a porous layer 513 that supports the resin layer 112. The porous layer 513 has the pores 513h penetrating the porous layer 513 in the thickness direction. A diameter of the pore 513h increases stepwise in a direction from the resin layer 112 toward the porous layer 513. Even with such a configuration, a similar effect as that of Modification Example 2 can be obtained.

The shapes of the pores 413h and 513h in Modification Example 2 and Modification Example 3 may be applied to the pores 313h and 314h in Modification Example 1. That is, the diameter of the pore 313h may increase continuously or stepwise as a distance from the resin layer 112 increases. The same applies to the pore 314h. In this case, the diameter of the pores 313h in an upper surface of the porous layer 313 is preferably larger than the diameter of the pores 314h in a lower surface of the porous layer 314.

### EXAMPLES

Next, Examples will be described.

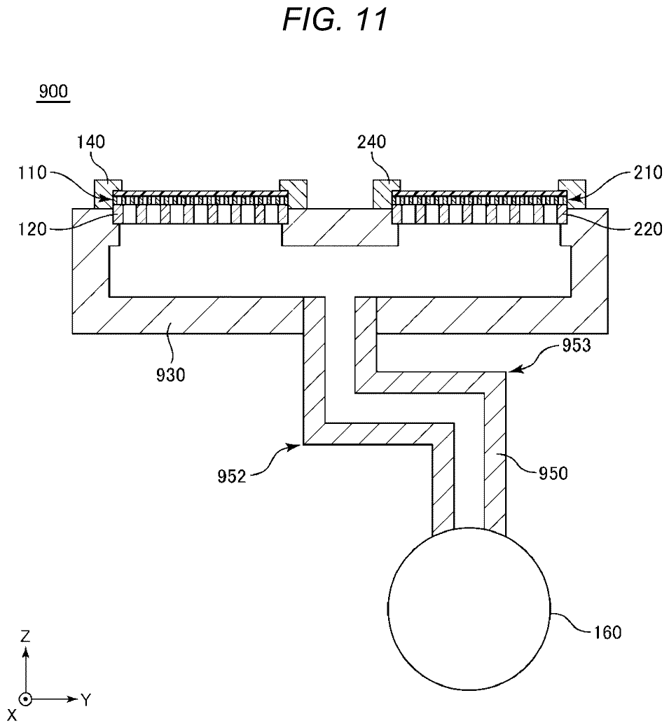

FIG. 11 is a cross-sectional view illustrating a separation device 900 according to Comparative Example 1.

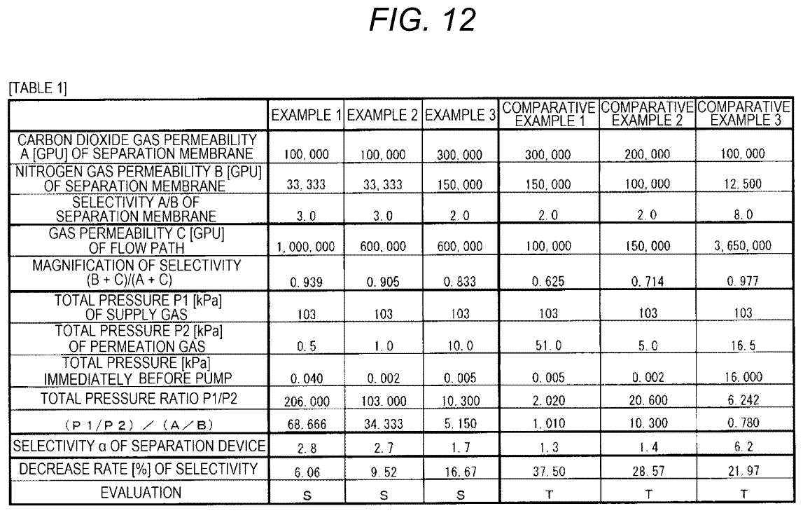

FIG. 12 is Table 1 illustrating configurations and evaluation results of separation devices in Examples 1 to 3 and separation devices in Comparative Examples 1 to 3.

A simulation was performed using spreadsheet software as to how the selectivity α of the separation device changes depending on a pressure reduction amount of the pump of the separation device and the gas permeability C of the flow path.

The separation devices according to Example 1, Example 2, Example 3, Comparative Example 1, Comparative Example 2, and Comparative Example 3 were set. An atmosphere temperature of the separation device was set to 20° C. A supply gas supplied to the separation device contains a carbon dioxide gas and a nitrogen gas. By simulating the atmosphere, the total pressure P1 of the supply gas was 103 kPa, and a concentration of the carbon dioxide gas was 400 ppm.

The separation device according to Example 1 was set to have a similar structure as the separation device 200 according to the second embodiment. That is, it is assumed that the separation device according to Example 1 includes a first separation membrane, a first porous plate, a first accommodation portion, a first pipe, a second separation membrane, a second porous plate, a second accommodation portion, a second pipe, a third pipe, a fourth pipe, and a pump. Then, as illustrated in Table 1, the carbon dioxide gas permeability A and the nitrogen gas permeability B of the separation membrane were set. The selectivity A/B of the separation membrane was calculated based on the carbon dioxide gas permeability A and the nitrogen gas permeability B.

A total pressure immediately before the pump in Example 1 was set to 0.040 kPa. The total pressure immediately before the pump corresponds to a pressure reduction amount of the pump. Although not illustrated in the table, set values of the flow path such as an area of the separation membrane, an opening area and a thickness of the porous plate, an inner diameter and a total length of the accommodation portion, an inner diameter and a total length of the pipe, and a loss factor based on a shape of an inlet portion were set. The area of the separation membrane corresponds to the area of the inlet of the flow path. Based on a set value of the flow path, a density of the nitrogen gas, and the like, a pressure loss when the nitrogen gas flows through the flow path was simulated using a theoretical equation for the pressure loss by Darcy-Weisbach or the like. Then, the gas permeability C of the flow path was calculated based on the pressure loss. The total pressure P2 of the permeation gas in the accommodation portion was simulated based on the pressure loss, the total pressure immediately before the pump, and the like.

The magnification of selectivity (B+C)/(A+C) was calculated based on the carbon dioxide gas permeability A, the nitrogen gas permeability B, and the gas permeability C. The total pressure ratio P1/P2 and (P1/P2)/(A/B) were calculated based on the total pressure P1 of the supply gas and the total pressure P2 of the permeation gas.

When (P1/P2)/(A/B)≥1 was satisfied, it was considered that the gas permeability C had a dominant effect on the selectivity α of the separation device, and the selectivity α of the separation device was calculated based on (Formula 12). Meanwhile, when 1>(P1/P2)/(A/B) was satisfied, it was considered that the total pressure ratio P1/P2 had a dominant effect on the selectivity α of the separation device, and the total pressure ratio P1/P2 was set as the selectivity α of the separation device. Results are shown in Table 1.

A structure of the separation device according to Example 2 is similar as a structure of the separation device according to Example 1 except that lengths of the first pipe and the second pipe are increased. Therefore, the gas permeability C in Example 2 was lower than the gas permeability C in Example 1. In Example 2, a set value of the total pressure immediately before the pump was set to a value smaller than that in Example 1.

A structure of the separation device according to Example 3 is similar as the structure of the separation device according to Example 2. In Example 3, the carbon dioxide gas permeability A was set to a value larger than that in Example 2, the nitrogen gas permeability B was set to a value larger than that in Example 2, and a total pressure immediately before the pump was set to a value larger than that in Example 2.

As illustrated in FIG. 11, in the separation device 900 according to Comparative Example 1, it is assumed that the first separation membrane 110 and the second separation membrane 210 are fixed to one accommodation portion 930, and a pipe 950 coupling the accommodation portion 930 and the pump 160 has two bent portions 952 and 953 instead of a linear shape. An inner diameter of the pipe 950 was set to a value smaller than an inner diameter of a pipe in Example 1. Therefore, the gas permeability C in Comparative Example 1 was lower than the gas permeability C in Examples 1 to 3. The carbon dioxide gas permeability A, the nitrogen gas permeability B, and the total pressure immediately before the pump were set to the same values as in Example 3.

A structure of the separation device according to Comparative Example 2 is similar as a structure of the separation device according to Comparative Example 1 except that a length of the pipe 950 is shortened. Therefore, the gas permeability C in Comparative Example 2 was higher than the gas permeability C in Comparative Example 1. In Comparative Example 2, the carbon dioxide gas permeability A was set to a value smaller than that in Comparative Example 1, the nitrogen gas permeability B was set to a value smaller than that in Comparative Example 1, and a total pressure immediately before the pump was set to a value smaller than that in Comparative Example 1.

A structure of the separation device according to Comparative Example 3 is similar as the structure of the separation device according to Example 1 except that lengths of the first pipe and the second pipe are shortened and inner diameters of the first, second, and fourth pipes are increased. Therefore, the gas permeability C in Comparative Example 3 was higher than the gas permeability C in Examples 1 to 3. In Comparative Example 3, the nitrogen gas permeability B was set to a value smaller than that in Example 1, and a total pressure immediately before the pump was set to a value larger than that in Example 1.

In Example 2, Example 3, and Comparative Examples 1 to 3, similarly to Example 1, the selectivity A/B of the separation membrane, the magnification of selectivity (B+C)/(A+C), the total pressure P2 of the permeation gas, the total pressure ratio P1/P2, (P1/P2)/(A/B), and the selectivity α of the separation device were calculated. For Examples 1 to 3 and Comparative Examples 1 to 3, a decrease rate of the selectivity α of the separation device relative to the selectivity A/B of the separation membrane was calculated. Then, the separation device was evaluated according to the following evaluation criteria. Results are shown in Table 1.
S: decrease rate of selectivity is 20% or less
T: decrease rate of selectivity exceeds 20%

In the separation devices according to Examples 1 to 3, (P1/P2)/(A/B)≥1, and 1>(B+C)/(A+C)≥0.8. In all of these cases, the decrease rate of the selectivity was 20% or less. Therefore, it was found that the separation devices according to Examples 1 to 3 had good selectivity α relative to the selectivity A/B of the separation membrane. In particular, the decrease rate of the selectivity in Example 1 is smaller than the decrease rate in Examples 2 and 3. It is considered that this is because a pressure loss of a flow path in Example 1 is smaller than a pressure loss of a flow path in Examples 2 and 3.

In the separation device according to Comparative Examples 1 and 2, (P1/P2)/(A/B) was ≥1, but 0.8>(B+C)/(A+C). The decrease rate of the selectivity in these cases exceeded 20%. This is considered to be because, although a pressure reduction amount of the pump was sufficient, a pressure loss in a flow path in Comparative Examples 1 and 2 was larger than a pressure loss of a flow path in Examples 1 to 3.

In the separation device according to Comparative Example 3, 1>(B+C)/(A+C)≥0.8, but 1>(P1/P2)/(A/B). The decrease rate of the selectivity in this case also exceeded 20%. This is considered to be because a pressure loss of the flow path was reduced, but a pressure reduction amount of the pump was not sufficient.

As described above, it was found that it is important to satisfy both (P1/P2)/(A/B)≥1 and 1>(B+C)/(A+C)≥0.8 in order to improve the selectivity oa of the separation device. The inventors of the present application performed supplementary experiments and confirmed that a similar tendency as a simulation result was obtained. It was confirmed that a flow path having the gas permeability C in Table 1 can be achieved by using the above-described method for reducing the pressure loss of the flow path. Similarly, it was also confirmed that the total pressure ratio P1/P2 in Table 1 can be achieved by adjusting the pressure reduction amount of the pump.

The separation device according to the present disclosure is described above based on the plurality of embodiments and the plurality of modification examples illustrated, but the present disclosure is not limited thereto.

For example, in the separation device according to the present disclosure, each part of the above-described embodiment and modification examples may be replaced with any component having a similar function, or any component may be added to the above-described embodiment and modification examples. The same applies to the method for designing the separation device according to the present disclosure.

What is claimed is:

1. A separation device for selectively separating a carbon dioxide gas from a supply gas containing the carbon dioxide gas and a nitrogen gas, the separation device comprising:
a separation membrane including a porous body and a resin layer disposed on the porous body and configured to selectively allow the carbon dioxide gas contained in the supply gas to permeate toward the porous body;
an accommodation portion holding the separation membrane and formed with an accommodation space for accommodating a permeation gas that permeates the separation membrane;
a pipe coupled to the accommodation portion; and
a pump configured to reduce a pressure in the accommodation space via the pipe and draw in the permeation gas, wherein
500,000 GPU≥A≥1,000 GPU, in which A is carbon dioxide gas permeability of the separation membrane,
(P1/P2)/(A/B)≥1, in which B is nitrogen gas permeability of the separation membrane, P1 is a total pressure of the supply gas, and P2 is a total pressure of the permeation gas in the accommodation space, and
1>(B+C)/(A+C)≥0.8, in which a flow path of the permeation gas between the separation membrane and the pump includes the accommodation space and an internal space of the pipe, and C is gas permeability of the flow path.

2. The separation device according to claim 1, wherein
$$15 \geq ( P 1 / P 2 ) / ( A / B ) .$$

3. The separation device according to claim 1, further comprising:
another separation membrane including another porous body and another resin layer disposed on the other porous body and configured to selectively allow the carbon dioxide gas contained in the supply gas to permeate toward the other porous body;
another accommodation portion holding the other separation membrane and formed with another accommodation space for accommodating another permeation gas that permeates the other separation membrane; and
another pipe coupled to the other accommodation portion, wherein
the pump is configured to reduce a pressure in the other accommodation space via the other pipe.

4. The separation device according to claim 1, wherein
in the flow path, a diameter of an inlet portion through which the permeation gas flows from the accommodation portion into the pipe gradually decreases from upstream toward downstream.

5. The separation device according to claim 1, wherein
a portion from the separation membrane to the flow path allowing the accommodation space of the accommodation portion and the internal space of the pipe to communicate is linearly formed.

6. The separation device according to claim 1, wherein
the pipe extends linearly.

7. The separation device according to claim 1, wherein
the porous body includes a porous layer supporting the resin layer,
the porous layer has pores penetrating the porous layer in a thickness direction, and
a diameter of the pores increases continuously or stepwise in a direction from the resin layer toward the porous layer.

8. The separation device according to claim 1, wherein
the porous body includes a plurality of stacked porous layers,
each of the plurality of porous layers has pores penetrating the plurality of porous layers in a thickness direction, and
the pores of the porous layer farther away from the resin layer have a larger diameter.

9. The separation device according to claim 1, wherein
the porous body contains a polymer material, a ceramic material, or a metal material.

10. The separation device according to claim 1, wherein
the resin layer contains organopolysiloxane.

11. A method for designing a separation device that selectively separates a carbon dioxide gas from a supply gas containing the carbon dioxide gas and a nitrogen gas, the method for designing a separation device comprising:
selecting a separation membrane including a porous body and a resin layer disposed on the porous body and configured to allow the carbon dioxide gas contained in the supply gas to permeate toward the porous body; and
designing an accommodation portion holding the separation membrane and formed with an accommodation space for accommodating a permeation gas that permeates the separation membrane, a pipe coupled to the accommodation portion, and a pump configured to reduce a pressure in the accommodation space via the pipe and draw in the permeation gas, wherein
a flow path of the permeation gas between the separation membrane and the pump includes the accommodation space and an internal space of the pipe,
in the selecting, the separation membrane satisfying 500,000 GPU≥A≥1,000 GPU is selected, in which A is carbon dioxide gas permeability of the separation membrane, and
in the designing,
the pump configured to reduce the pressure in the accommodation space is selected such that (P1/P2)/(A/B)≥1, in which B is nitrogen gas permeability of the separation membrane, P1 is a total pressure of the supply gas, and P2 is a total pressure of the permeation gas in the accommodation space, and
the flow path is designed such that 1>(B+C)/(A+C)≥0.8, in which C is gas permeability of the flow path.

12. The method for designing a separation device according to claim 11, wherein
in the designing, a shape of the accommodation space, an inner diameter of the pipe, a length of the flow path, surface roughness of the flow path, and the number of bent portions of the flow path are adjusted such that 1>(B+C)/(A+C)≥0.8.
